(19) United States
(12) Patent Application Publication
(10) Pub. No.: US 2009/0236256 A1
(43) Pub. Date: Sep. 24, 2009

(54) PATCH FOR DAMAGED BAGS

(76) Inventor: Douglas W. Shinnick, Rockaway, NJ (US)

Correspondence Address: Mr. Walter J. Tencza Jr., Suite 210, 100 Menlo Park, Edison, NJ, 08837, US

(21) Appl. No.: 12/052,809

(22) Filed: Mar. 21, 2008

(51) Int. Cl. B32B 37/12; B65B 7/02; B65D 85/00

(52) U.S. Cl. 206/525; 428/41.8; 383/109; 156/69

(57) ABSTRACT

A device is provided comprised of a first layer, a second layer, and a third layer. The first layer lies on top of the second layer, and the second layer lies on top of the third layer. The device may be substantially in the shape of a sheet having a width of about six inches and a length of about eight inches. The first layer may be comprised of a backing. The second layer may be comprised of an adhesive. The third layer may be comprised of a clear material. In at least one embodiment the first layer can be removed from the device, exposing the second layer, and the second layer can then be adhered to a bag to cover an opening in the bag with a combination of the second layer and the third layer.

### FIELD OF THE INVENTION

This invention relates to improved methods and apparatus concerning repairing damaged bags.

### BACKGROUND OF THE INVENTION

Fertilizers, grass seed, and top soil typically come in fifty pound bags, and very often the bags rip, tear, or break open during handling, and are usually “repaired” on the spot using packing tape, duct tape or other means (which takes some time and doesn't always stick too well) and then sold at a lesser price or given away, depending on the extent of the damage and loss of material. These bags of material may also break after being sold, which can result in time-consuming cleanup and possible fines depending on the content of the bag.

### SUMMARY OF THE INVENTION

The present invention in one or more embodiments provides an apparatus comprising a device comprised of a first layer, a second layer, and a third layer. The first layer lies on top of the second layer, and the second layer lies on top of the third layer. The device may be substantially in the shape of a sheet having a width of about six inches and a length of about eight inches. The first layer may be comprised of a backing. The second layer may be comprised of an adhesive. The third layer may be comprised of a clear material. In at least one embodiment the first layer can be removed from the device, exposing the second layer, and the second layer can then be adhered to a bag to cover an opening in the bag with a combination of the second layer and the third layer.

The apparatus may include the bag. The backing may be a paper backing. The third material may be clear plastic, such as a clear plastic polymer. The first layer may be cut substantially down a middle of the first layer. The bag may include fertilizer. The adhesive may be substantially stronger than that used for clear packing tape.

In at least one embodiment, the present invention provides a method comprised of removing a first layer from a device, exposing a second layer, and adhering the second layer to a bag to cover an opening in the bag with a combination of the second layer and a third layer. The device may be of the one or more configurations previously specified.

### BRIEF DESCRIPTION OF THE DRAWINGS

FIG. 1 shows a top view of a device in accordance with an embodiment of the present invention;

FIG. 2 shows a side view of the device of FIG. 1;

FIG. 3 shows a perspective view of a bag with a tear, opening, or hole; and

FIG. 4 shows a perspective view of the bag of FIG. 3 with the tear, opening, or hole covered with a patch in accordance with an embodiment of the present invention.

### DETAILED DESCRIPTION OF THE DRAWINGS

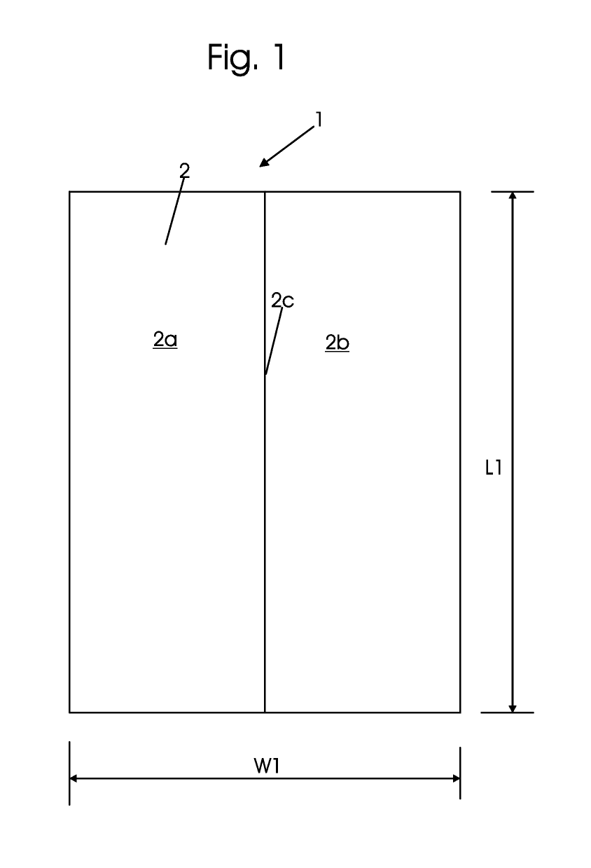

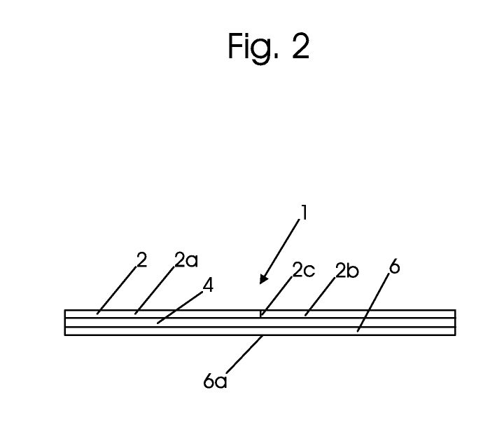

FIG. 1 shows a top view of a device 1 in accordance with an embodiment of the present invention. FIG. 2 shows a side view of the device 1.

The device 1 includes a first layer 2, a second layer 4, and a third layer 6. The first layer 2 is comprised of a first portion 2a and a second portion 2b. The first layer 2 may be a paper backing which has been cut down the middle along a line 2c. The first layer 2 is typically removable. The second layer 4 may be an adhesive. The third layer 6 may be a clear plastic, such as a clear plastic polymer.

The second layer 4 may be an acrylic adhesive, such as a permanent acrylic adhesive. The adhesive for the second layer 4 is typically substantially stronger than that used for clear packing tape.

The device 1 may have the overall appearance of a sheet having three layers. The device 1 may have a width W1 which may be about six inches and a length L1 which may be about eight inches.

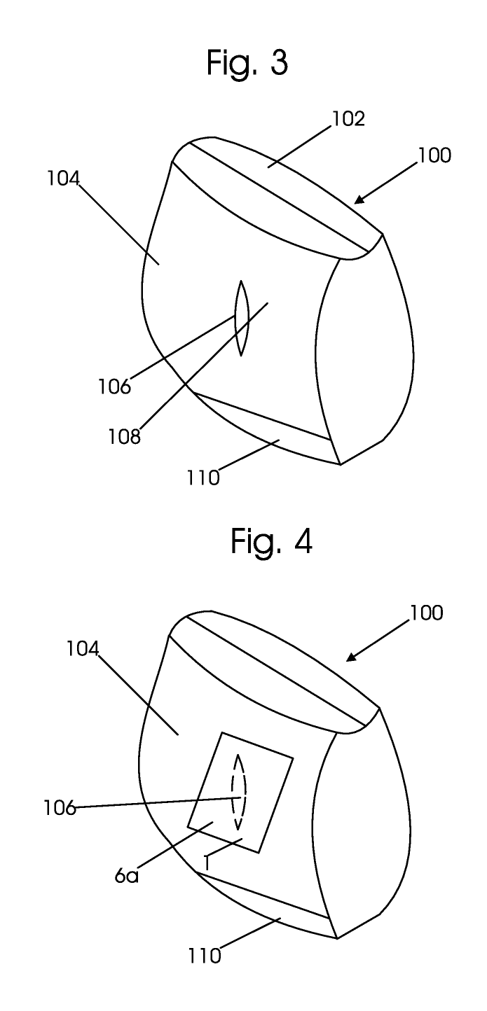

In operation, the device 1 can be used as follows. FIG. 3 shows a perspective view of a bag 100 with a tear, opening, or hole 106 which an inner chamber 108 of the bag 100 and thereby allows contents in the inner chamber 108 of the bag 100 to spill out. The bag 100 includes a body 104, and a top flap 102 which typically substantially enclose and seal in the contents in the bag 100 inside the inner chamber 108, with the exception of the tear, opening, or hole 106. The bag 100 may contain fertilizer, grass seed, or top soil in its inner chamber 108. The bag 100 may also include a bottom flap 110, similar to the top flap 102, which together with body portion 104, and top flap 102 typically substantially encloses and seals in the contents in the bag 100 inside the inner chamber 108, with the exception of the tear, opening, or hole 106.

FIG. 4 shows a perspective view of the bag 100 of FIG. 3 with the tear, opening, or hole 106 covered by the second layer 4 and third layer 6 of the device 1. In order to cover the tear, opening, or hole 106, the backing or first layer 2 is peeled off of the adhesive or second layer 4. Next the adhesive or second layer 4 is adhered to the body portion 4 surrounding tear, opening, or hole 106 so that the tear, opening, or hole 106 is covered by the clear plastic third layer 6. This also substantially encloses and seals the inner chamber 108 so that contents within the bag 100 or kept from spilling out.

The device 1 can be used to patch, bandage, and/or repair broken plastic or paper bags of fertilizer, grass seed, top soil, or any other non-food item that is sold or stored in a plastic or a paper bag.

One or more embodiments of the present invention result in a much quicker and neater repair, resulting in less lost product, and less money lost because of a damaged item. One or more embodiments of the present invention are quicker, stick better, and look much neater than a traditional prior art “tape” fix, which result in better ability to sell a product and less lost profits. One or more embodiments of the present invention provide a quick, easy, and presentable repair versus prior art techniques of using duct tape or clear plastic packing tape from a tape gun.

One or more embodiments of the present invention provide one hundred percent visibility to the bag underneath, which is required to be visible on fertilizers, pesticides, fungicides, etc.

The adhesive provided for layer 4 is preferably stronger than typically provided for typical prior art packing tape ensuring that layer 4 keeps bagged product from spilling out.

The device 1 reduces the amount of spilled product due to tears and breaks, which results in less lost dollars. It provides a more sellable repair to broken or torn bags, which results in more sales dollars on broken/torn items. It reduces the likelihood of EPA (environmental protection agency) or DEP (department of environmental protection) fines due to bags leaking fertilizers, pesticides, and fungicides, etc.

One or more embodiments of the present invention provide a quicker repair than tape, as it requires less time to peel the paper backing and apply, rather than peeling and applying several lengths of tape from a roll or dispenser.

One or more embodiments of the present invention are cost effective, generally amounting to just a small fraction of the cost of the bagged product to be repaired and sold.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a device comprised of
a first layer;
a second layer; and
a third layer;
wherein the first layer lies on top of the second layer, and the second layer lies on top of the third layer;
wherein the device is substantially in the shape of a sheet having a width of about six inches and a length of about eight inches;
wherein the first layer is comprised of a backing;
wherein the second layer is comprised of an adhesive; and
wherein the third layer is comprised of a clear material;
and wherein the first layer can be removed from the device, exposing the second layer, and the second layer can then be adhered to a bag to cover an opening in the bag with a combination of the second layer and the third layer.

2. The apparatus of claim 1 further comprising
the bag.

3. The apparatus of claim 1 wherein
the backing is a paper backing.

4. The apparatus of claim 1 wherein
the third material is a clear plastic.

5. The apparatus of claim 1 wherein
the third material is a clear plastic polymer.

6. The apparatus of claim 1 wherein
the first layer is cut substantially down a middle of the first layer.

7. The apparatus of claim 2 wherein
the bag includes fertilizer.

8. The apparatus of claim 1 wherein
the adhesive is substantially stronger than that used for clear packing tape.

9. A method comprising:
removing a first layer from a device, exposing a second layer, and adhering the second layer to a bag to cover an opening in the bag with a combination of the second layer and a third layer;
wherein the device is comprised of
the first layer;
the second layer; and
the third layer;
wherein the first layer lies on top of the second layer, and the second layer lies on top of the third layer;
wherein the device is substantially in the shape of a sheet having a width of about six inches and a length of about eight inches;
wherein the first layer is comprised of a backing;
wherein the second layer is comprised of an adhesive; and
wherein the third layer is comprised of a clear material.

10. The method of claim 9 wherein
the backing is a paper backing.

11. The method of claim 9 wherein
the third material is a clear plastic.

12. The method of claim 9 wherein
the third material is a clear plastic polymer.

13. The method of claim 9 wherein
the first layer is cut substantially down a middle of the first layer.

14. The method of claim 10 wherein
the bag includes fertilizer.

15. The method of claim 9 wherein
the adhesive is substantially stronger than that used for clear packing tape.
